(19) United States
(12) Patent Application Publication
(10) Pub. No.: US 2005/0120289 A1
(43) Pub. Date: Jun. 2, 2005

(54) Apparatus, system, method, and computer program product for document management

(76) Inventor: Akira Suzuki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/979,158

(22) Filed: Nov. 3, 2004

(30) Foreign Application Priority Data
Nov. 27, 2003 (JP) 2003-397624
Aug. 6, 2004 (JP) 2004-231129

(51) Int. Cl. G06F 17/00

(52) U.S. Cl. 715/500

(57) ABSTRACT

A document management apparatus includes a document output unit configured to control outputting of a document, a management level setting unit configured to set a management level of a document to be output by the document output unit, and a document management unit configured to manage the document output unit and the document management level setting unit. The document management unit determines an output form of the document in the document output unit based on the set management level when output of the document is instructed.

### CROSS-REFERENCE TO RELATED APPLICATIONS

This patent document is based on and claims priority to Japanese patent applications No. 2003-397624 filed on Nov. 27, 2003, and No. 2004-231129 filed on Aug. 6, 2004, the entire contents of each of which are hereby incorporated herein by reference.

### BACKGROUND OF THE INVENTION

1. Field of the Invention

The present invention generally relates to a document management apparatus, a system, a method, and a computer program product for managing an electronic document of one or plural pages, and more particularly to a document management apparatus for managing document output operations such as a printing, save, etc. appropriately based on setting a management level for a document.

2. Description of the Background Art

In the background art, for example Japanese Laid-Open patent Publication No. 2003-316774 (the entire contents of which are hereby incorporated herein by reference) a document management system is described that manages a life cycle of a document by using a security level. However, the management of a document output (for example, printing a hard copy of the document) from the system is not considered. Thus, it is difficult to manage document data appropriately with such a background art.

Further, Japanese Laid-Open patent Publication No. 2003-323457 (the entire contents of which are hereby incorporated herein by reference) describes a system that arranges a desired classification by analyzing the contents of document data. Japanese Laid-Open patent Publication No. 2001-324898 (the entire contents of which are hereby incorporated herein by reference) describes a system that can add a security ground tint to a printed document that is capable of being visible when a document is copied, to thereby provide a visible indication that a document is a copy. This provides a security level as it provides an indication that a document has been copied.

Furthermore, for example, it is known that when an electronic document is made, putting various management information in a document attribute (i.e., property) is done for managing the made document. Putting such management information in the document attribute requires extra operations by a document creator, and thus it is difficult to practice putting management information in an attribute of the document. In addition, even if such putting management information in the attribute of the document is performed, without management of a document output (for example, printing a hard copy of the document and document save operations), document management cannot be appropriately and fully executed.

However, in the above-mentioned background art, managing a document output and save operations appropriately is not described.

### SUMMARY OF THE INVENTION

An object of the present invention is to provide a document management apparatus configured to determine an output form of a document based on a management level of the document. The present invention also provides a method and a computer program product to perform such document management.

According to an aspect of the present invention, a document management apparatus includes a document output unit configured to control outputting of a document, a management level setting unit configured to set a management level of a document to be output by the document output unit, and a document management unit configured to control the document output unit and the document management level setting unit. The document management unit determines an output form of the document output from the document output unit based on the set management level when output of the document is instructed.

According to another aspect of the present invention, a document management system includes a document output unit configured to control outputting of a document, a document management level setting unit configured to set a management level of a document to be output by the document output unit, and a document management unit configured to control the document output unit and the document management level setting unit. The document management unit determines an output form in the document output unit based on the management level when output of the document is instructed.

Using the above-described document management apparatus or system, it is possible to determine an output form of a document based on a management level of the document, to thereby manage the document appropriately. Furthermore, other aspects of the present invention provide a method of using the document management apparatus or system and a computer program product for controlling a computer to execute the method.

These and other objects, features, and advantages of the present invention will become apparent upon consideration of the following description of the preferred embodiments of the present invention, taken in conjunction with the accompanying drawings.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings.

FIG. 1 is a schematic view of an in-house LAN system as a document management system in accordance with an aspect of the present invention.

FIGS. 2A and 2B are a flowchart sequence illustrating a process of managing a document in accordance with an aspect of the present invention.

FIG. 3A is an explanatory view of a pop-up window in accordance with an aspect of the present invention.

FIG. 3B is an explanatory view of an attribute (property) window in accordance with an aspect of the present invention.

FIGS. 4A and 4B are an explanatory view of transcribing prescribed information of a file compendium in the attribute of FIG. 3B to a cover of a document.

FIGS. 5A-5C are an explanatory view of transcribing prescribed information of a user option and prescribed information of a file compendium in the attribute of FIG. 3B to a header of a document.

FIG. 6 illustrates a schematic view of a document management system in accordance with an aspect of the present invention.

FIG. 7A is a flowchart sequence illustrating a process of managing a document based on the print management server 61 of FIG. 6.

FIGS. 7B1 and 7B2 are an explanatory view of a table stored in the print management server 61 of FIG. 6.

FIG. 8 is a functional block diagram of the in-house LAN (local area network) system of FIG. 1.

### DETAILED DESCRIPTION OF THE PREFERRED EMBODIMENTS

Referring now to the drawings, wherein like reference numerals designate identical or corresponding parts throughout the several views, non-limiting embodiments of the present invention are described. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner.

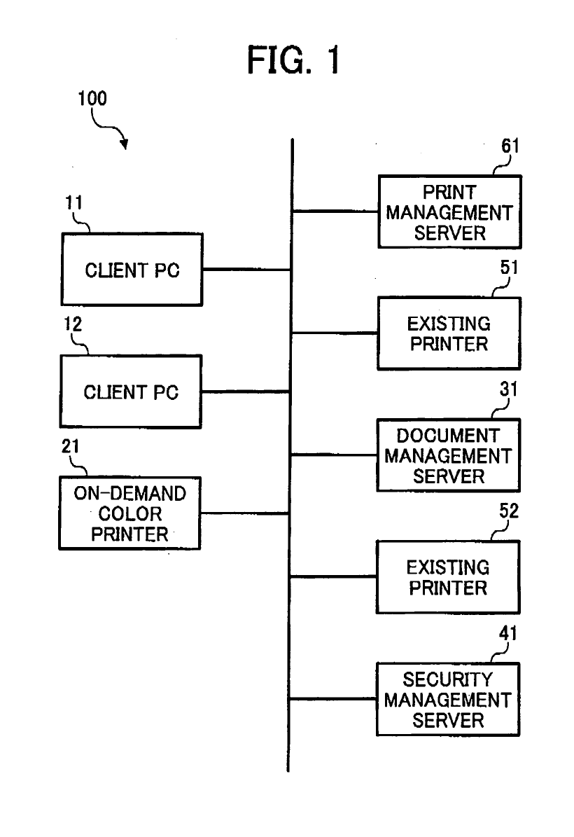

FIG. 1 illustrates a schematic view of an in-house LAN (local area network) system 100 as a document management system in accordance with an aspect of the present invention. The in-house LAN system 100 includes plural client PCs (personal computers) 11 and 12 having a document processing support tool built-in for supporting processing of document data including a prescribed attribute (i.e., property), and an on-demand color printer 21 adapted for printing a security ground tint capable of emerging when a document is copied (such as a print control apparatus described in Laid-Open patent Publication No. 2001-324898), as a part of a security feature.

In addition, the document processing support tool built in the above-mentioned client PCs 11 and 12 can be a support tool for transcribing various management information to an attribute (i.e., property) of a document processed by word-processing software when word-processing software is used in an electric computer (for example a personal computer). For example, the process of transcribing the attribute of a document is executed by a macro program built-in word-processing software that causes a CPU of the PCs 11 or 12 to transcribe various management information into the attribute.

Further, the in-house LAN system 100 includes a document management server 31, a security management server 41, an existing printer 51, an existing printer 52, and a print management server 61 adapted for managing the existing printers 51 and 52.

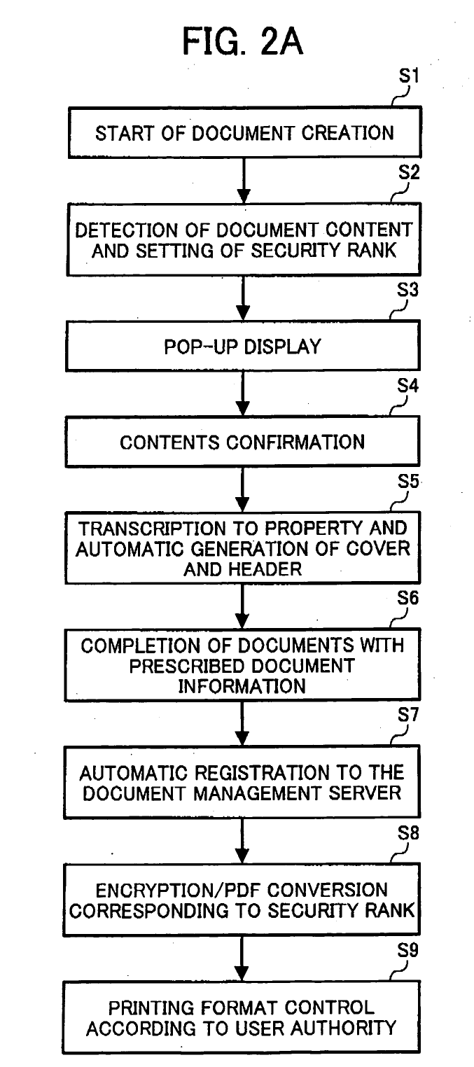

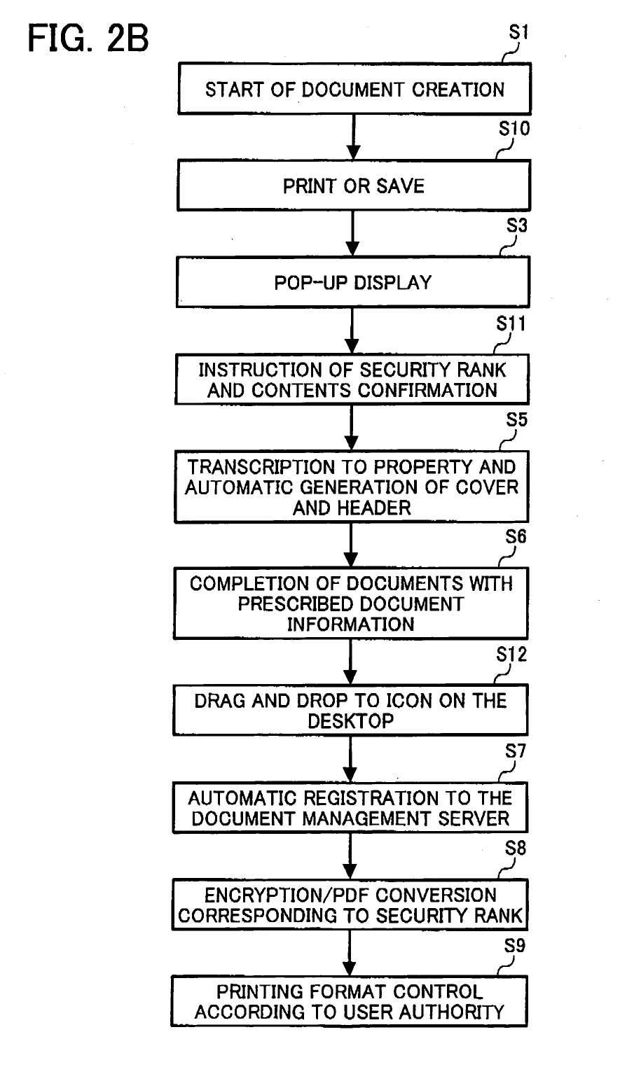

FIGS. 2A and 2B are a flowchart sequence illustrating a process of managing a document in accordance with an aspect of the present invention. FIG. 2A is a flowchart sequence in accordance with an aspect of an embodiment. FIG. 2B is a flowchart sequence in accordance with another aspect of the embodiment with certain alternative operations relative to the embodiment of FIG. 2A that may be useful in certain practical aspects. In addition, the same numerals indicated corresponding common flows in the following description.

In step S1 of FIGS. 2A and 2B, a document creation is started in any client PC 11, 12 that includes the above-mentioned document processing support tool. In FIG. 2A, a process of step S2 is executed by a trigger. The trigger is an implementation instruction of a macro program that runs a process of transcribing various information to the attribute, in the document processing support tool. In step S2, detection of a document content and setting of a security rank (i.e., management level) are performed. For example, detection of a document content and setting of a security rank (i.e., management level) may be performed based on the security management server 41 by using the document analysis system as described in Japanese Laid-Open patent Publication No. 2003-323457.

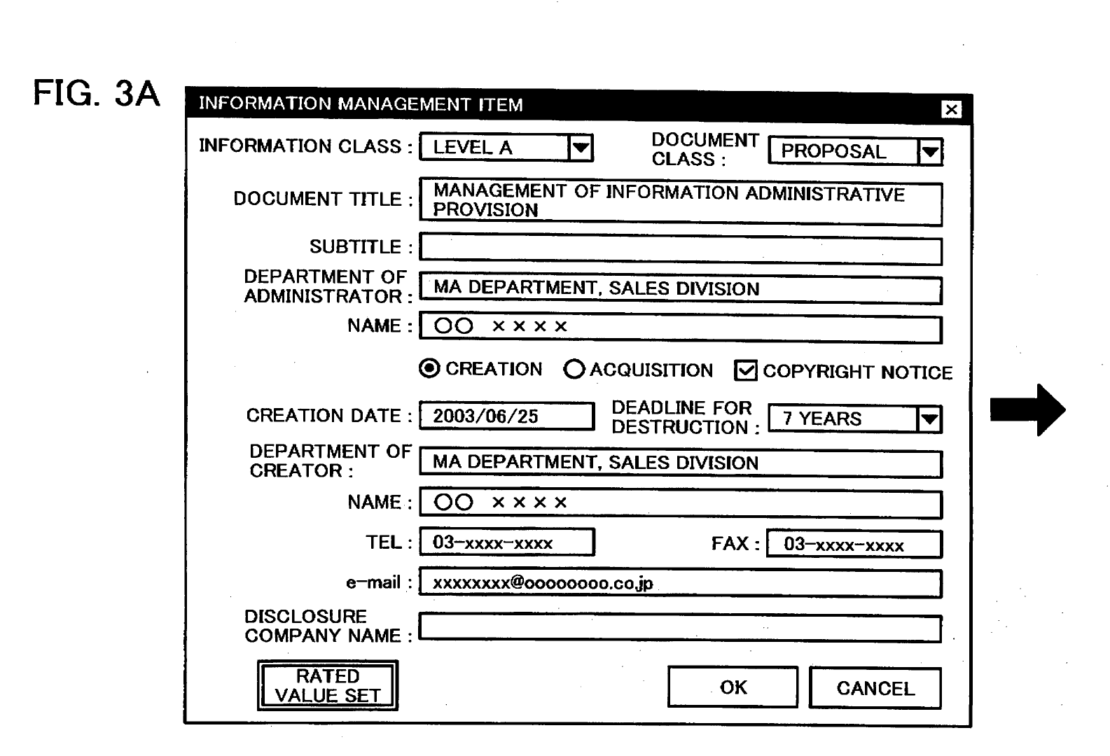

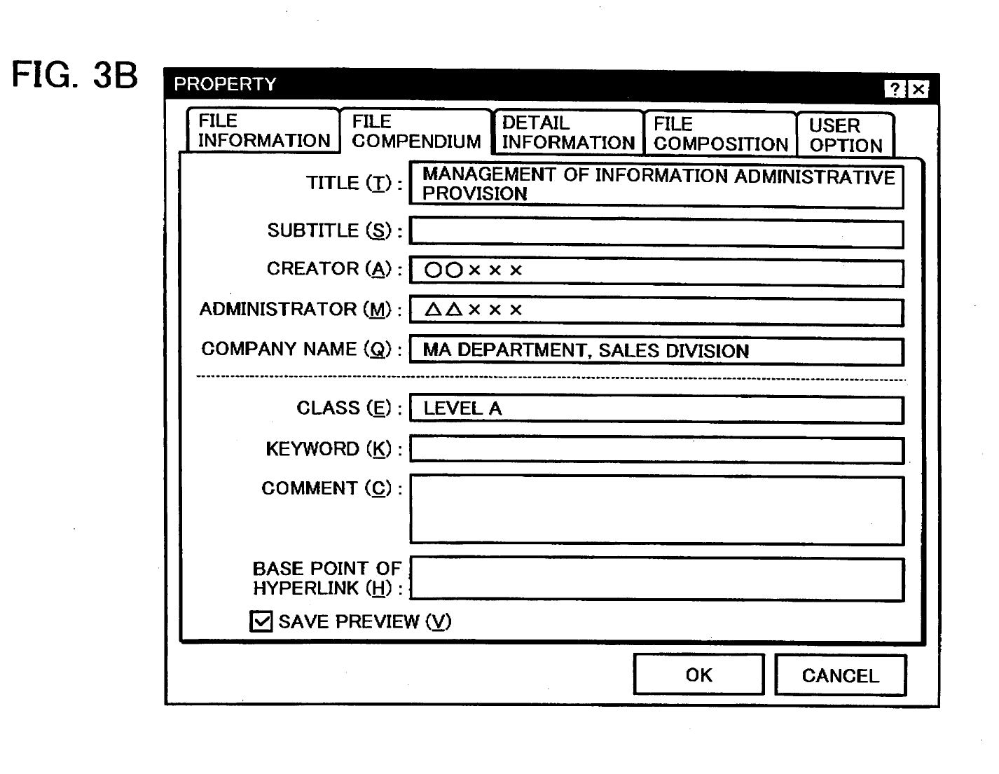

On the other hand, in FIG. 2B, a process of step S10 is executed based on a user indicating an instruction such as print or save. After step S2 or step S10, in step S3 of FIGS. 2A and 2B, a macro program in the document processing support tool for the transcription process to the attribute runs to cause a pop-up window to pop-up on a display. In a display of the client PCs 11 or 12 creating a document, a pop-up window as shown in FIG. 3A is displayed in step S3. For example, a name of a document creator and a department, etc. may be described in the pop-up window. This description may be done by default when a user of the client PCs 11 or 12 is specified. In addition, an information class as a management level, a document title, a subtitle, etc. may be described in the pop-up window. In step S4 of FIG. 2A, the contents in the pop-up window are confirmed. In step S11 of FIG. 2B, setting of a security rank and the contents in the pop-up window are confirmed.

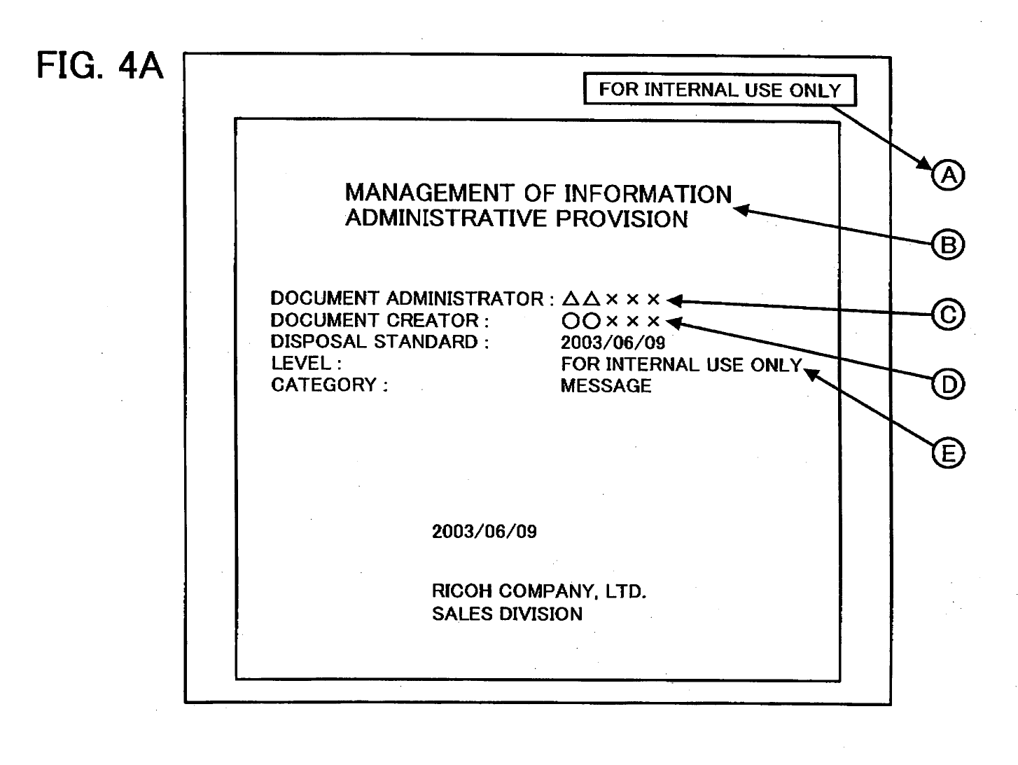

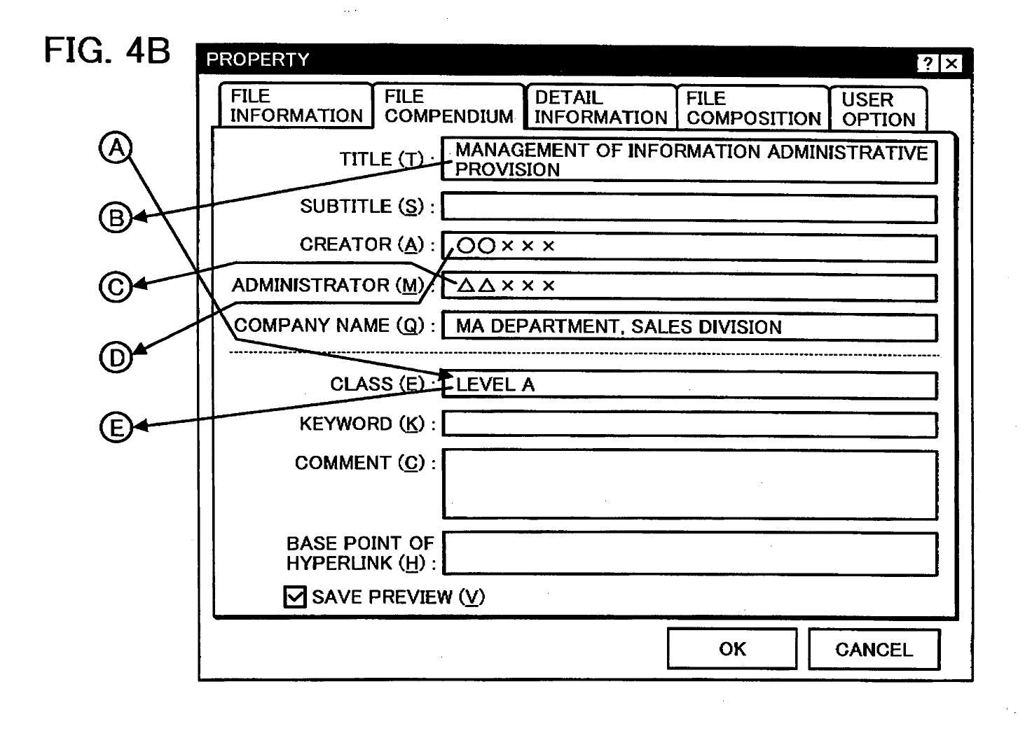

Therefore, in step S5 of FIGS. 2A and 2B, the contents of the pop-up window are transcribed to the attribute (i.e., property) of a document as shown in the FIG. 3B. Further, a cover for the document and a header are automatically generated. Referring to the file compendium in the attribute (i.e., property) as shown in FIGS. 4A and 4B, a document administrator, a document creator, a deadline for destruction, prescribed information corresponding to a management level (such as for internal use only), a category, etc. are transcribed in the cover of the document.

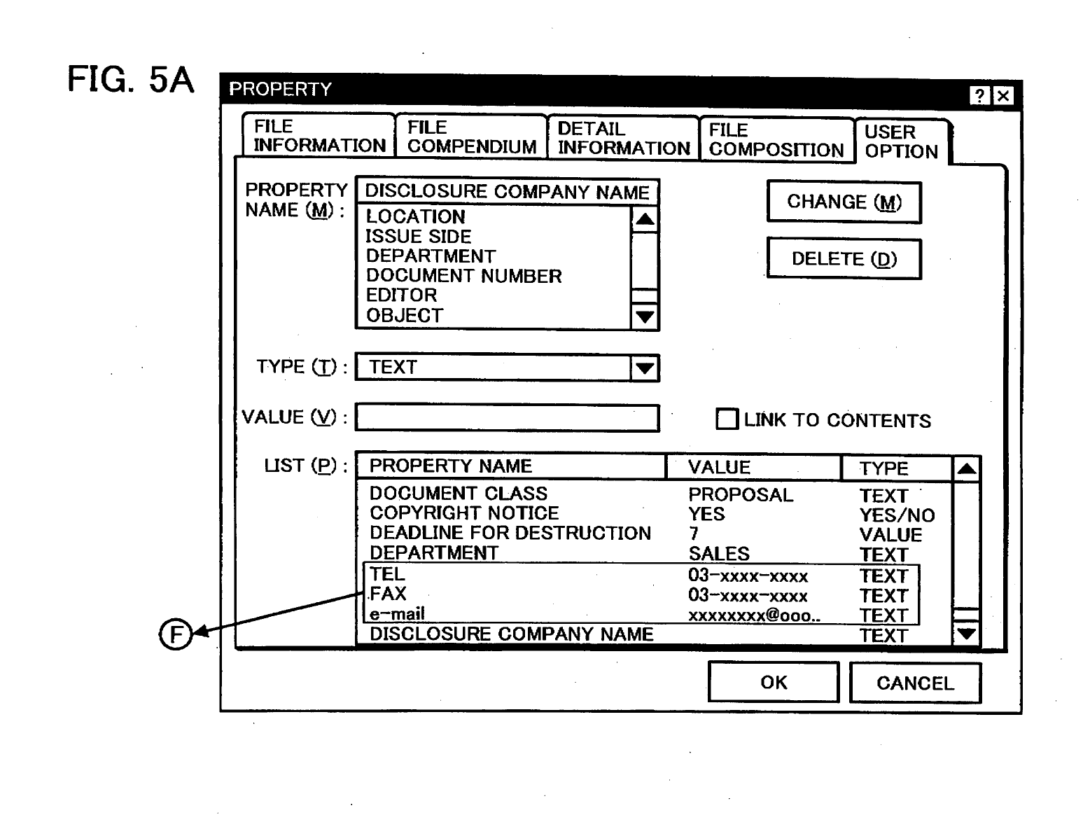

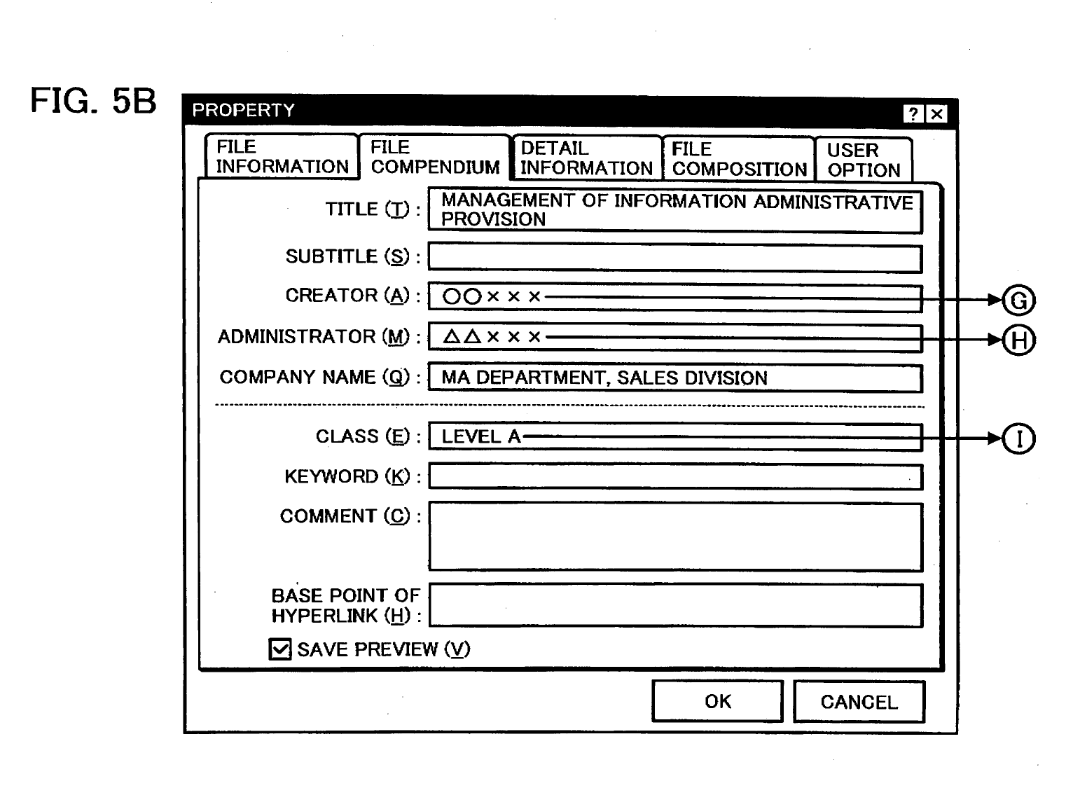

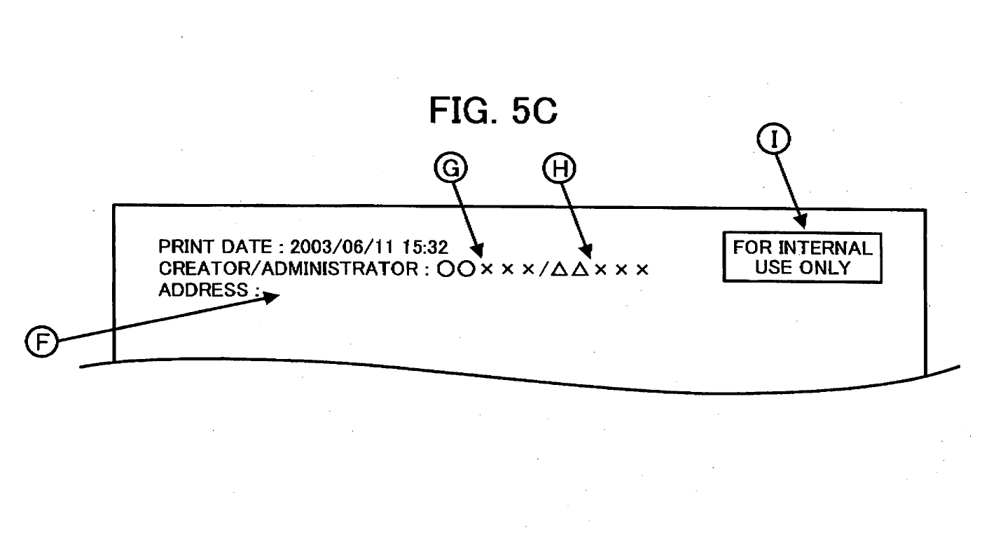

Further, referring to the file compendium and the user option in the attribute (i.e., property) as shown in FIGS. 5A-5C, the header is generated. Thus, the documents with prescribed document information (such as, the above-mentioned cover, the header) are completed (step S6 of FIGS. 2A and 2B). A process of step S7 of FIG. 2B is executed by a drag and drop of an icon on the desktop of the PCs 11 or 12 for running a program that causes a CPU of the PCs 11 or 12 to transfer various data to the document management server 31. On the other hand, a process of step S7 of FIG. 2A is executed automatically. In step S7 of FIGS. 2A and 2B, the documents completed by the process of step S6 are automatically registered in the document management server 31.

In step S8 of FIGS. 2A and 2B, the documents are saved based on the set security rank (i.e., management level). This save may be executed with the choice of a prescribed file format according to the security rank (i.e., management level). The file format includes, for example, a changeable format, an irrevocable format, and an encryption format. That is, in automatic registration of step S7 and the save of step S8, selection of a document save cabinet in the document management server 31 is executed according to the department of a creator and the document class. Further, according to the security level (i.e., management level), for example, (1) the document data is saved as it is when the security level is at a low level and the document can be later changed (the changeable format), (2) the document data is saved as a PDF (portable document file) including an ID for specifying a document creator when the security level is at a middle level and as the document is saved as a PDF it cannot be changed or modified (the irrevocable format) or (3) the document data is saved in an encryption format when the security level is at a high level (the encryption format).

In step S9 of FIGS. 2A and 2B, printing format control as an example of an output format according to the use authority is performed. This printing format control may, e.g., set permissible printing options according to a post in a company of the person requesting the output or printing of the document. For example, there may be no printing restriction of the encrypted document in step S8 to a person in a high position. In such an example, a person in a middle position may be able to print the documents with a prescribed security ground tint capable of being visible when a document is copied as described in Japanese Laid-Open patent Publication No. 2001-324898. In such an example, a person in a low position may only be able to refer to the documents on a display, but however may not be able to print out the documents. A temporary staff, etc. in this example may not be able to print out or even refer to the documents on a display. In addition, the correspondence between the above-mentioned management level and the printing format may be registered in the security management server 41. Therefore, it is possible to determine an output form of a document based on a management level of the document and manage the document appropriately.

The mechanisms and processes set forth in the present description may be implemented using a conventional general purpose microprocessor programmed according to the teachings in the present specification, as well be appreciated to those skilled in the relevant arts. Appropriate software coding can readily be prepared by skilled programmers based on the teachings of the present disclosure, as will also be apparent to those skilled in the relevant arts.

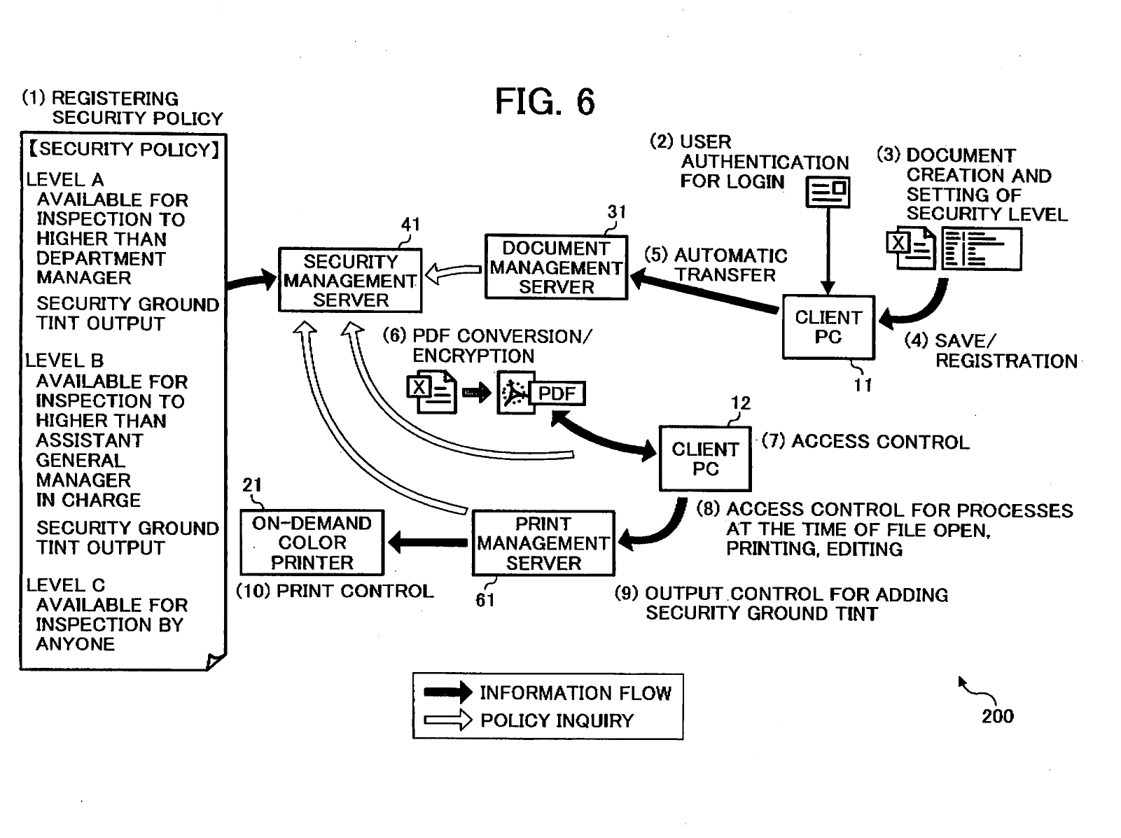

FIG. 6 illustrates a schematic view of a document management system 200 in accordance with an aspect of the present invention. As the procedure (1), a security policy is registered in the document management system 200. For example, a security policy may be registered in the security management server 41. In addition, the security policy may be determined as a document management provision by an information administrative provision. For example, level A as a security policy corresponds to a document available for inspection to a person higher than a department manager, and adding a security ground tint to a document when the document is printed. Level B corresponds to a document available for inspection to a person higher than an assistant general manager in charge, and adding a security ground tint to a document when the document is printed. Level C corresponds to a document available for inspection by anyone. In addition, the security management server 41 and the document management server 31 can be separate servers; however, some or all functions of the security management server 41 may be included in the document management server 31.

Next, as the procedure (2), a user authentication for login is executed based on an employee ID card at the client PCs 11 and 12. As the procedure (3), document creation and setting of a security level are executed. As the procedure (4), save and registration of document data are executed. As the procedure (5), the document data is automatically transferred to the document management server 31. As the procedure (6), PDF (including ID for specifying a document creator) conversion or encryption is executed according to the set security level. In addition, one client PC may execute processes of both of the client PCs 11 and 12.

As the procedure (7), access control based on the security policy is executed at the client PCs 11 and 12. As the procedure (8), access control for a process at the time of file opening, document printing, and editing is executed according to the security level. Further, as the procedure (9), for example, an output control for adding a security ground tint (for example, authority information) to a printout paper in the printer 21 is executed according to the security policy. At this output control according to the security policy, a judgment of the necessity for adding a security ground tint, a security ground tint type, and a security ground tint color, etc. are determined by making comparisons between user information and the security policy.

Further, as the procedure (10), a print control is executed according to the security policy in the existing printer 21. In addition, a print control for such an existing printer 21 is executed, for example, based on the print management server 61 as described in FIG. 1. The image data of the printed document may be saved in the print management server 61.

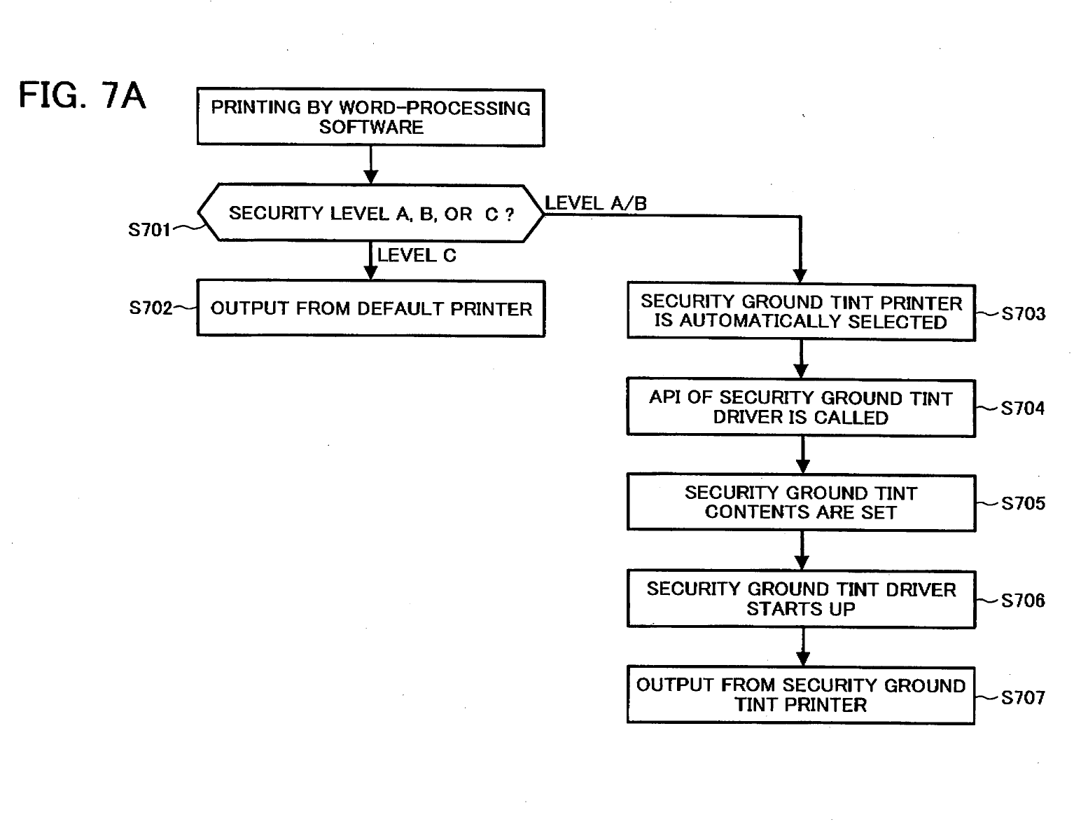

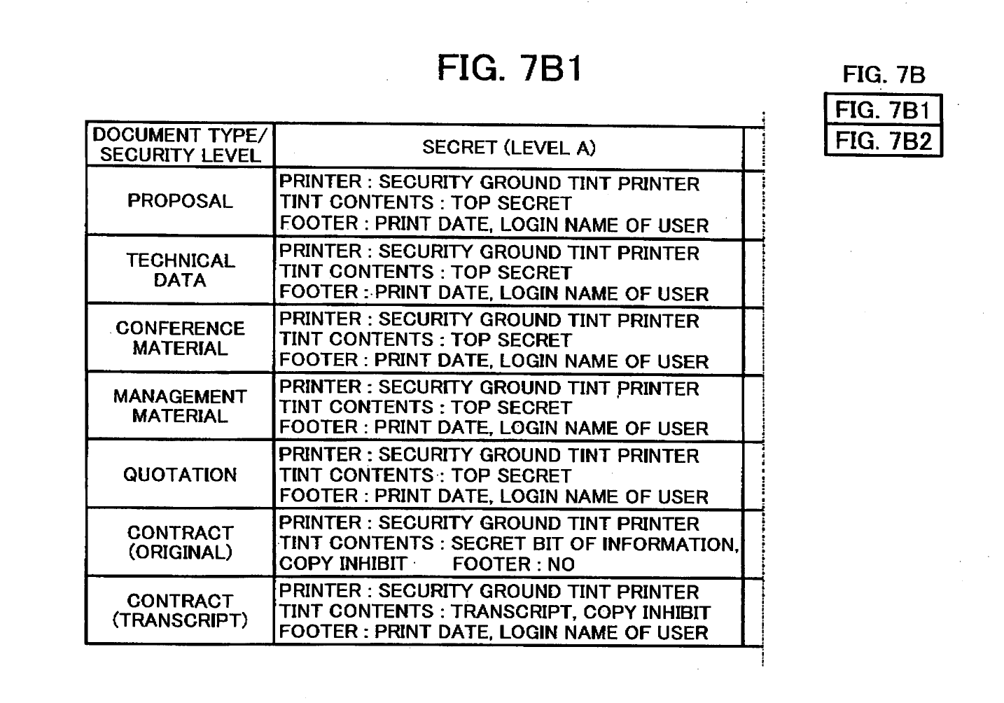

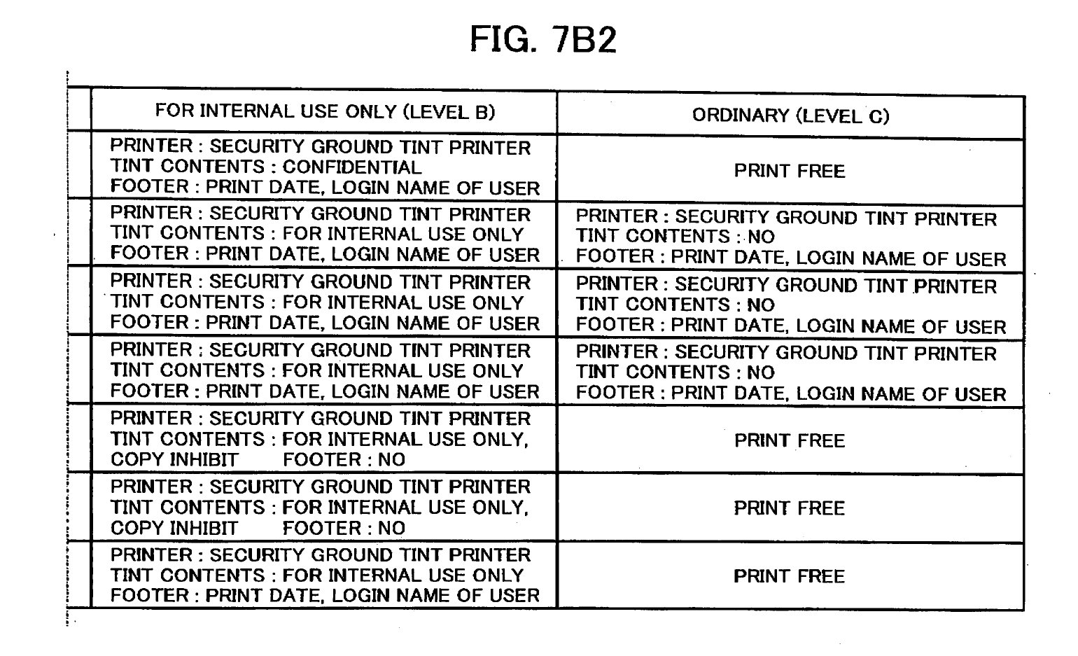

Next, a process of the print management server 61 is described in FIGS. 7A and 7B1, 7B2. FIG. 7A is a flowchart sequence illustrating a process of managing a document based on the print management server 61 of FIG. 6. FIGS. 7B1, 7B2 are an explanatory view of a table stored in the print management server 61. In step S701 of FIG. 7A, a security level for a document type is referenced. For example, as shown in FIGS. 7B1, 7B2, a document whose type is a proposal and whose security level is ordinary (level C) may be printed freely. In step S702, the document is printed out from a default printer, such as the existing printer 51 or 52 shown in FIG. 1.

On the other hand, for a document whose type is a proposal and whose security level is high (level A) or for internal use only (level B), a printer adapted for adding the security ground tint, such as the on-demand color printer 21 of FIG. 1, is automatically selected (step S3). Further, various settings such as a paper size, print condition, etc. are set. In step S4, the API (application programming interface) of a driver for adding the security ground tint is called, and the security ground tint contents are set (step S5). Next, the driver starts up (step S6), and the document with the added security ground tint is printed out from the on-demand color printer 21 of FIG. 1 (step S7).

Therefore, for example, when a security level is high (level A), a printer adapted for adding a security ground tint is automatically selected. Further, the term “Top Secret” can, as an example, be set as the security ground tint contents. A print date and a login name of a print user can also be displayed and printed in a footer. When a security level is for internal use only (level B), a printer adapted for adding a security ground tint is automatically selected. Further, the term “For Internal Use Only” can be set as the security ground tint contents. A print date and a login name of a print user can also be displayed and printed in a footer. In addition, according to a document type and a security level, various types of security ground tint and footers can be printed based on the table shown in FIGS. 7B1, 7B2. Therefore, it is possible to determine an output form of a document based on a management level of the document and to thereby manage the document appropriately.

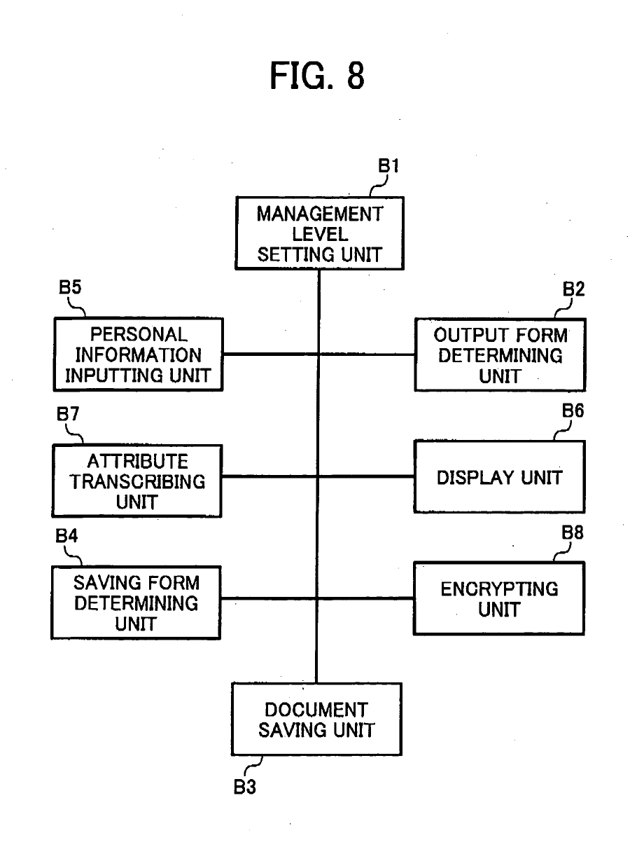

In addition, the functions of the above-mentioned document management server 31, the security management server 41, and the print management server 61 may be provided by a computer program adapted for executing the same functions or a computer readable medium storing the program. The present embodiment may be implemented by a program including the functional blocks shown in following FIG. 8.

FIG. 8 is a functional block diagram of the in-house LAN (local area network) system of FIG. 1. A document management program in accordance with an aspect of the present invention includes a management level setting block (unit) B1 for setting a management level of a created document and an output form determining block (unit) B2 for determining an output form of a document based on a management level when output of a document is instructed. Further, the document management program includes a document saving block (unit) B3 for saving document data, a saving form determining block (unit) B4 for determining a saving form of the document data based on a management level when saving of a document is instructed, a personal information inputting block (unit) B5 for inputting personal information for specifying a user associated with document creation, and a display block (unit) B6 for displaying various information including personal information.

Furthermore, the document management program includes an attribute transcribing block (unit) B7 for transcribing displayed information and a management level to an attribute added in the created document, an output form determining unit B2, and an encrypting block (unit) B8 for encrypting document data, etc.

In the block B2 for determining an output form, the output form of a document is determined based on a management level in the attribute. The output form may be determined based on a management level and personal information about a user requesting an output.

Obviously, numerous modifications and variations of the present invention are possible in light of the above teachings. It is therefore to be understood that within the scope of the appended claims, the present invention may be practiced otherwise than as specifically described herein.

1. A document management apparatus comprising:
a document output unit configured to control outputting of a document;
a management level setting unit configured to set a management level of the document to be output by the document output unit; and
a document management unit configured to manage the document to be output by the document output unit;
wherein the document management unit determines an output form of the document output by the document output unit based on the set management level when output of the document is instructed.

2. The document management apparatus according to claim 1, further comprising:
a document saving unit configured to save document data;
wherein the document saving unit determines a saving form of the document data based on the set management level when saving of the document is instructed.

3. The document management apparatus according to claim 1, wherein the document management unit adds prescribed information including personal information for specifying a user with the management level to the created document as an attribute, and
wherein the document management unit determines an output form of the document based on the management level in the attribute.

4. The document management apparatus according to claim 3, wherein the document management unit determines the output form of the document in the document output unit based on the management level and personal information of a user requesting the output of the document.

5. The document management apparatus according to claim 2, wherein the document management unit determines the saving form of the document data in the document saving unit by selecting a format from formats including a changeable format, an irrevocable format, and an encryption format, based on the set management level.

6. A document management system comprising:
a document output unit configured to control outputting of a document;
a management level setting unit configured to set a management level of the document to be output by the document output unit; and
a document management unit configured to manage the document to be output by the document output unit;
wherein the document management unit determines an output form of the document in the document output unit based on the set management level when output of the document is instructed.

7. The document management system according to claim 6, further comprising:
a document saving unit configured to save document data;
wherein the document saving unit determines a saving form of the document data based on the management level when saving of the document is instructed.

8. The document management system according to claim 6, wherein the document management unit adds prescribed information including personal information for specifying a user with the management level to the created document as an attribute,
and wherein the document management unit determines an output form of the document based on the management level in the attribute.

9. The document management system according to claim 8, wherein the document management unit determines the output form of the document in the document output unit based on the set management level and personal information of a user requesting the output of the document.

10. The document management system according to claim 7, wherein the document management unit determines the saving form of the document data in the document saving unit by selecting a format from formats including a changeable format, an irrevocable format, and an encryption format, based on the set management level.

11. A method of performing document management, comprising:
setting a management level of a document;
determining an output form of the document based on the set management level when output of the document is instructed.

12. The method according to claim 11, further comprising:
saving document data;
determining a saving form of the document data based on the set management level when saving of the document is instructed.

13. The method according to claim 11, further comprising:
transcribing prescribed information including personal information for specifying a user and the set management level to an attribute added in the created document; and
determining an output form of the document based on the set management level in the attribute.

14. The method according to claim 13, further comprising:
displaying an entry screen for inputting the prescribed information on a display.

15. The method according to claim 13, further comprising:
determining the output form of the document based on the set management level and personal information of a user requesting the output of the document.

16. The method according to claim 12, further comprising:
determining the saving form of the document by selecting a format from formats including a changeable format, an irrevocable format, and an encryption format, based on the set management level.

17. A computer program product stored in a computer readable storage medium for carrying out a method of performing document management, comprising:
setting a management level of a document;
determining an output form of the document based on the set management level when output of the document is instructed.

18. The program product according to claim 17, further comprising:
saving document data; and
determining a saving form of the document data based on the set management level when saving of the document is instructed.

19. The program product according to claim 17, further comprising:
transcribing prescribed information including personal information for specifying a user and the set management level to an attribute added in the created document;
determining an output form of the document based on the set management level in the attribute.

20. The program product according to claim 19, further comprising:
determining the output form of the document based on the set management level and personal information of a user requesting the output of the document.

21. The program product according to claim 18, further comprising:
determining the saving form of the document by selecting a format from formats including a changeable format, an irrevocable format, and an encryption format, based on the set management level.
